(19) United States
(12) Patent Application Publication
(10) Pub. No.: US 2008/0144500 A1
(43) Pub. Date: Jun. 19, 2008

(54) CONTROL FRAME FEATURE ON DEMAND IN A WIRELESS COMMUNICATION SYSTEM

(75) Inventors: Ye Chen, Schaumburg, IL (US); Ivan N. Vukovic, Arlington Heights, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/611,335

(22) Filed: Dec. 15, 2006

(51) Int. Cl. H04L 12/28

(52) U.S. Cl. 370/235

(57) ABSTRACT

In a wireless network, a device monitors at least one parameter that indicates collision status in the network; compares the at least one parameter to a predefined control frame threshold that is based on a criterion other than packet-size; and activates a control frame feature in the device for sending a control frame prior to data transmission, when the at least one parameter exceeds the control frame threshold. In an 802.11 network, the control frames are RTS (request-to-send) and CTS (clear-to-send) frames. The parameters being monitored can include: a number of acknowledgement and RTS frames detected from a hidden terminal, when the device is in a backoff state; a number of retransmission attempts by the device; and a collision rate determined and transmitted by another device in the wireless network to which the device intends to send data.

### TECHNICAL FIELD

The present invention relates to wireless communications and more particularly to a method and apparatus for using a control frame prior to data transmission based on certain parameters in a wireless communication system.

### BACKGROUND

Wireless communication systems are well known in the art. Types of wireless communication systems include infrastructure-based wireless networks and ad hoc (one of the forms also known as “mesh”) wireless networks, such as those based on Institute of Electronics and Electrical Engineers (IEEE) 802.11 standards, which define physical and Medium Access Control (MAC) layers for devices communicating in the network. Wireless local area networks (WLANs) based on IEEE 802.11 standards afford users the ability to move around within a broad coverage area and still be connected to the network. WLAN technology employs special wireless transport mechanisms at different layers that support high bandwidth connectivity between wireless devices.

In a WLAN, the MAC layer performs the functions of controlling access to the medium, ensuring reliable data recovery, and protecting data and admission control. These functions are supported by services that are implemented by messages from one device (station) to the other. The sending of messages includes transmission of frames of different types such as management frames, control frames, data frames, etc. Control frames include an Acknowledgement frame (ACK), a Request To Send (RTS) frame, and a Clear To Send (CTS) frame, which are used for collision avoidance of data frames between devices in the network and for reliable data recovery.

The basic medium access protocol is a distributed coordination function (DCF) that allows for automatic medium sharing between compatible physical layers through the use of carrier sense medium access with collision avoidance (CSMA/CA) and a random backoff time following a busy medium condition. In addition, all directed traffic uses immediate positive acknowledgement (ACK frame), where retransmission is scheduled by the sender if no ACK is received. The CSMA/CA protocol is designed to reduce the collision probability between multiple stations accessing a medium, at the point where collisions would most likely occur.

Carrier sense is performed using both physical and virtual mechanisms. The virtual carrier-sense mechanism is achieved by distributing reservation information announcing the impending use of the medium. The exchange of RTS and CTS frames prior to the actual data frame is one means of distribution of this medium reservation information. The RTS and CTS frames contain a Duration/ID field that defines the period of time that the medium is to be reserved to transmit the actual data frame and the returning ACK frame. All stations within the reception range of either the originating station (which transmits the RTS) or the destination station (which transmits the CTS) can, thus, learn of the medium reservation. Accordingly, a station can be unable to receive from the originating station, yet still know about the impending use of the medium to transmit a data frame.

The RTS/CTS frame exchange process also performs the tasks of fast collision inference and a transmission path check. If the CTS frame is not detected by the station transmitting the RTS frame, the transmitting station may repeat the process (after observing the other medium-use rules) of sending the RTS frame. Since RTS and CTS frames are short control frames, the collision status of frames in the medium is detected quickly as compared to when a long data frame is transmitted and a return acknowledgement frame is not received. Another advantage of using RTS and CTS frames occurs where multiple Basic Service Sets (BSSs) using the same channel (medium) overlap because the medium reservation mechanism works across the boundaries of a basic service area.

However, the RTS and CTS frames add overhead inefficiencies in the WLAN. Therefore, the RTS/CTS mechanism is not always desirable prior to every data frame transmission. Presently the use of the RTS/CTS mechanism is based on a RTS threshold that is based only on packet size. Since the use of the RTS/CTS mechanism may not be justified for a short data frame, a receiver decides to use RTS/CTS mechanism by comparing the packet size with the RTS threshold, and uses the RTS/CTS mechanism only where the intended data frame packet size exceeds the RTS threshold. However, basing the use or disabling of a control frame mechanism (such as RTS/CTS) only on packet size has shortcomings.

The use of a control frame mechanism is beneficial in scenarios that indicate collision status in the network. For example, use of a control frame mechanism is beneficial when the medium is heavily loaded with a lot of contending users or when there is possible interference from a station which is hidden to the station transmitting a data frame, regardless of frame size. Conversely, the use of a control frame mechanism is not beneficial when the medium is lightly loaded or the medium is loaded from only a few users or in a scenario when the presence of a hidden terminal is not a concern for the transmitting station. Further, in a WLAN where channel error is the main factor causing transmission failure, the error probability for four frame exchange (e.g., RTS/CTS/DATA/ACK) is double as compared to two frame exchange (e.g., DATA/ACK) in a noisy medium. Hence, in this case the use of a control frame mechanism is not beneficial regardless the packet size. Also in an application like Voice over IP (VOIP) in a WLAN, the usage of a control frame mechanism can consume up to one third of system resources. A control frame mechanism (as in the prior art) that depends only on the criterion of packet size does not address any of these above scenarios.

Thus, there exists a need for a technique to activate a control frame mechanism in a wireless device prior to data transmission based on criteria other than packet size, including an indication of collision status in a wireless network.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram of a wireless communication system, wherein embodiments of the invention can be implemented.

FIG. 2 is a block diagram illustrating portions of a communication device in accordance with embodiments of the invention.

FIG. 3 is a flow diagram illustrating a method for using a control frame feature in accordance with embodiments of the invention.

FIG. 4 is a flow diagram illustrating a method for using a control frame feature based on receiving response control frames or ACK frames from unknown devices, in accordance with embodiments of the invention.

FIG. 5 is a block diagram of a wireless communication system implementing the method illustrated in FIG. 4.

FIG. 6 is a flow diagram illustrating a method for using a control frame feature based on a received collision status indication, in accordance with embodiments of the invention.

FIG. 7 is a block diagram of a wireless communication system implementing the method illustrated in FIG. 6.

FIG. 8 and FIG. 9 illustrate waveforms considered in determining the collision status indication for facilitating the method illustrated in FIG. 6.

FIG. 10 is a flow diagram illustrating a method for using a control frame feature based on counting retransmission attempts, in accordance with embodiments of the invention.

FIG. 11 is a block diagram of a wireless communication system implementing the method illustrated in FIG. 10.

### DETAILED DESCRIPTION

Before describing in detail embodiments that are in accordance with the present invention, it should be observed that the embodiments reside primarily in combinations of method steps and apparatus components related to a method and apparatus for using a control frame prior to data transmission based on certain parameters in a wireless communication system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and apparatus for using a control frame prior to data transmission based on certain parameters in a wireless communication system described herein. The non-processor circuits may include, but are not limited to, a radio receiver, a radio transmitter and user input devices. As such, these functions may be interpreted as steps of a method for using a control frame prior to data transmission based on certain parameters in a wireless communication system described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment of the present invention can be implemented as a computer-readable storage element having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), a EPROM (Erasable Programmable Read Only Memory), a EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, is a method, apparatus and computer-readable storage element for the dynamic activation and deactivation of a control frame feature in a device for sending a control frame prior to a data transmission. The device monitors at least one parameter in a wireless network that indicates collision status in the network; compares the at least one parameter to a predefined control frame threshold that is based on a criterion other than packet-size; and activates a control frame feature in the device for sending a control frame prior to data transmission, when the at least one parameter exceeds the control frame threshold. In an 802.11 wireless local area network, the control frames are RTS (request-to-send) and CTS (clear-to-send) frames. The parameters being monitored can include: a number of acknowledgement and CTS frames detected from a hidden terminal, when the device is in a backoff state; a number of retransmission attempts by the device; and a collision rate value determined and transmitted by another device in the wireless network to which the device intends to send data.

Dynamic use of the control frame feature in the device based upon these exemplary environmental parameters (instead of on packet size as in the prior art) improves system capacity by activating the control frame feature when the environmental parameters indicate a probability of error by collision, regardless of packet size. Embodiments of the invention further achieve an optimal tradeoff by distinguishing between packet loss caused by collision and packet loss caused by channel error so that the control frame feature is not used during the latter error scenario. As discussed above, use of the control frame feature is not beneficial where packet loss is caused by channel error since the probability for error doubles with a four frame exchange as compared to a two frame exchange. Embodiments of the invention are further compatible with current IEEE 802.11 standards and can be easily implemented using minimal modifications to an existing MAC protocol. Those skilled in the art will realize that the above recognized advantages and other advantages described herein are merely exemplary and are not meant to be a complete rendering of all of the advantages of the various embodiments of the present invention.

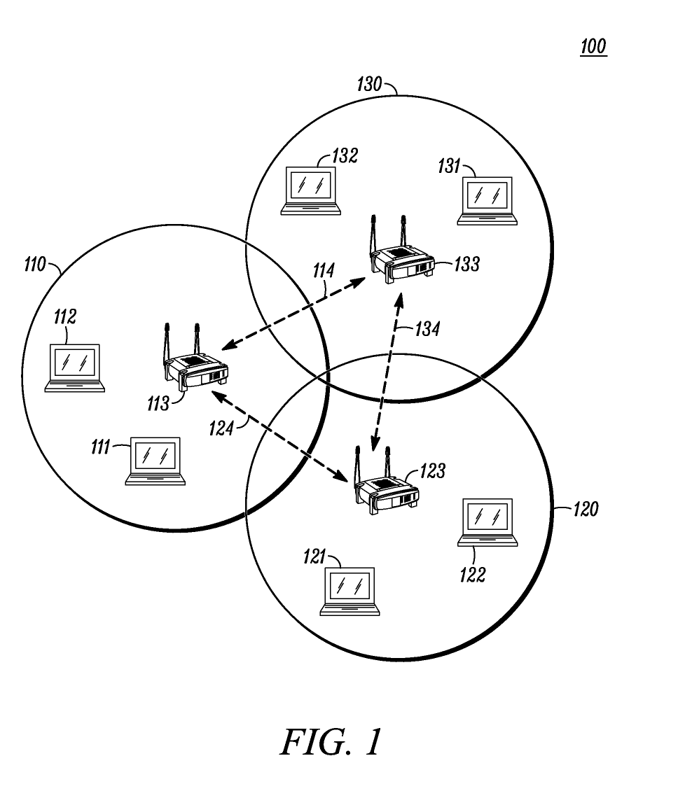

Referring now to the drawings, and in particular FIG. 1, a block diagram of a wireless communication system, wherein embodiments of the present invention can be implemented, is shown and indicated generally as 100. To facilitate understanding of the teachings herein, system 100 (and the systems illustrated by reference to specific embodiments) is described herein as an 802.11 WLAN, meaning that devices comprising the system are operable and communicate in accordance with IEEE 802.11 standards. Moreover, system 100 includes three infrastructure-based basic service sets (BSS) 110, 120 and 130 (as described in additional detail below) managed by three access points and the three access points construct a simple mesh system.

Those skilled in the art, however, will recognize and appreciate that the specifics of this illustrative system example are not specifics of the invention itself and that the teachings set forth herein are applicable in a variety of alternative settings. Accordingly, the teachings described do not depend on the type of the wireless communication system but they can be applied to any type of wireless communication system that can use a control frame prior to sending a data transmission—including ad-hoc networks (for instance 802.11 mesh system consisting three access points shown in system 100), although an infrastructure-based 802.11 WLAN is used as an example shown in this and the following implementations and embodiments. As such, other alternative implementations of using different types of wireless communication systems with two or more communicating devices are contemplated and are within the scope of the various teachings described.

System 100 comprises a plurality of communication devices described in additional detail below that communicate with each other using a wireless medium. The wireless medium in this case is a shared wireless medium such that only one such device can transmit at a given time, otherwise a collision condition occurs that may lead to packet loss. Each communication device comprises a processing device, e.g., a DSP, for processing a digitized data signal including modulating or demodulating the data signal onto or off of one or more carrier signals. Each communication device further comprises transceiver apparatus (including both transmitting and receiving apparatus, also referred to in the art as radio front-end apparatus) that may include a power amplifier, one or more filters, an equalizer, a duplexer, and an antenna to transmit and receive the modulated signal. Moreover, the communication devices typically further comprise additional elements as are needed in a commercial embodiment including, but not limited to, memory, user input devices, display devices, analog-to-digital and digital-to-analog converters, and the like. The communication devices may be, for instance, portable or mobile radios, laptops, Personal Digital Assistants, etc. As mentioned earlier, the communication devices are operable in accordance with IEEE 802.11 standards.

In this exemplary implementation, shown in system 100 are three access points 113, 123 and 133 with radio coverage areas 110, 120 and 130 respectively. An access point (AP) generally has two interfaces, which include at least one interface on the WLAN and one wired interface. An AP takes 802.11 frames from the WLAN and bridges them to another AP via wireless link or converts the packets to be suitable for the wired format to wired network (typically Ethernet) via the wired interface and vice versa. This allows stations to send packets to and to receive packets from the wired network, and from the Internet. It should be noted that the term “frame” as used herein generally describes a formatted block information (data, control, etc.) carried by the network, and includes blocks commonly referred to as packets, frames, and the like. Access points 113, 123 and 133 are coupled via communication links 114, 124 and 134 (shown as dashed lines). In this implementation, links 114, 124 and 134 logically represent wireless communication links between the access points. In some other implementations, links 114, 124 and 134 further represent above-described wired links.

System 100 further comprises of a plurality of wireless communication devices 111, 112, 121, 122, 131 and 132, which are also commonly referred to as stations. Stations 111 and 112 are within the coverage area of AP 113, which provides services (such as authentication/association services and data transmission services, for instance) for these and any other stations within its coverage area. Stations 121 and 122 are within the coverage area of AP 123. Stations 131 and 132 are within the coverage area of AP 133. Stations communicate (e.g., send and receive frames with control or data information) with other stations via the access point within a given coverage area using a wireless medium comprising one or more radio frequency (RF) propagation channels. It should be further noted that although a limited number of devices are shown for the ease of illustration, system 100 can comprise more or fewer stations and/or access points.

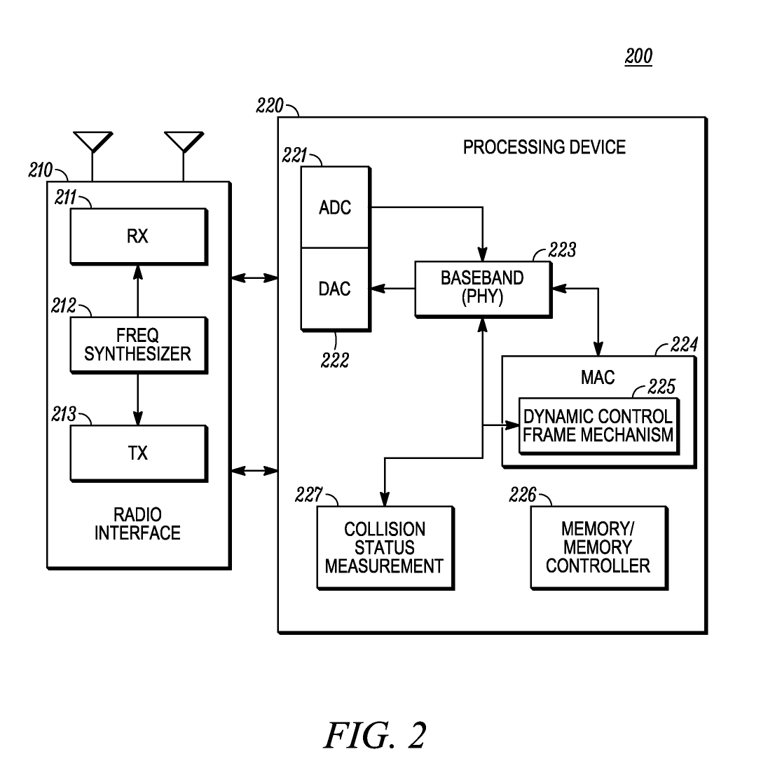

Turning now to FIG. 2, a block diagram of portions of a communication device that are configured in accordance with embodiments of the invention are shown and generally indicated as apparatus 200. Apparatus 200 may be included in any of the access points and stations illustrated in FIG. 1, and includes those portions of a device that may be used in implementing embodiments of the invention described herein. Accordingly apparatus 200 comprises a processing device 220 and a radio interface 210 to the wireless medium, which is operatively coupled to the processing device 220.

The radio interface unit 210 comprises receiver apparatus (RX) 211, a frequency synthesizer 212 and transmitter apparatus (TX) 213. TX 213 comprises at least a high power amplifier (HPA). TX 213 receives a baseband signal from the processing device 220, upconverts the baseband to radio frequency at a carrier frequency generated by the frequency synthesizer 212, amplifies the RF signal using the HPA and transmits the modulated signal using an antenna. The receiver apparatus (RX) 211 receives a RF signal from the antenna. Receiver apparatus 211 comprises elements such as, for instance a preselector filter that can be a simple band pass filter designed to pass a desired signal and reject spurious out-of-band signals and a downconverter to downconvert the received signal from RF to baseband frequencies generated by frequency generator 212. The receiver apparatus 213 provides the baseband signal to the processing device 220 for further processing.

Processing device 220 comprises an Analog To Digital Converter (ADC) 221, a Digital To Analog Converter (DAC) 222, a baseband processing unit 223, a MAC processing unit 224, a memory/memory controller unit 226, and a collision status unit 227. When the communication device is in a receive mode, the ADC 221 samples and digitizes the baseband signal received from RX apparatus 211 to provide time domain samples to the baseband processing unit 223 for further processing. Baseband unit 223 performs functions needed to generate serial output bits that are ideally substantially those that were transmitted by a transmitting device. These serial output bits can, for example, be put into one or more output formats for a user of the receiving device to see via a display device or to hear via a speaker or provided to an application in the communication device.

When the communication device is in a transmit mode, baseband processing unit 223 receives serial bits that represent control or data information that the communication device intends to transmit and performs functions needed to generate a time domain signal sequence from the serial bits. Baseband unit 223 may employ any suitable modulation scheme to generate the signal sequence such as, for instance, Gausian Frequency Shift Keying (GFSK), Differential Binary Phase Shift Keying (DBPSK), Differential Quadrature Phase Shift Keying (GQPSK), Pulse Position Modulation (PPM), etc. Baseband processing unit passes the time domain signal sequence to the DAC 222, which converts it to the analog baseband signal that is provided to TX apparatus 213.

The baseband processing unit 223 further logically represents information received from hardware (e.g., on a wireless card), which performs the physical layer carrier sensing to determine whether the channel is busy or free. The baseband unit 223 provides this information regarding the current availability of the channel to the MAC processing unit 224 to use in determining when to send data. The MAC processing unit uses standard protocols (such as those defined in the 802.11 standards) or proprietary protocols to determine when to send the data. The MAC processing unit 224 is further configured with a dynamic control frame feature mechanism 225, in accordance with the teachings herein, for dynamically determining when to send a control frame prior to the data transmission.

Further information regarding a number of attempts to retransmit a data packet (also referred to herein as a number of “retransmission attempts”) and a number of acknowledgement and/or CTS frames can be extracted by baseband processing unit 223 and provided to the MAC processing unit 224 for implementing embodiments of the dynamic control frame mechanism 225 as described below. Moreover, the MAC processing unit 224 can read from memory 226 a collision rate value provided by a destination device to implement yet another embodiment of the control frame mechanism 225. Still further information extracted by the baseband processing unit may include detected collisions from two or more devices attempting to send data packets to the device comprising apparatus 200. This further collision information is provided to the collision status measurement unit 227, which uses this information to compute a collision rate value that is provided to other devices in the network to implement an embodiment of the invention.

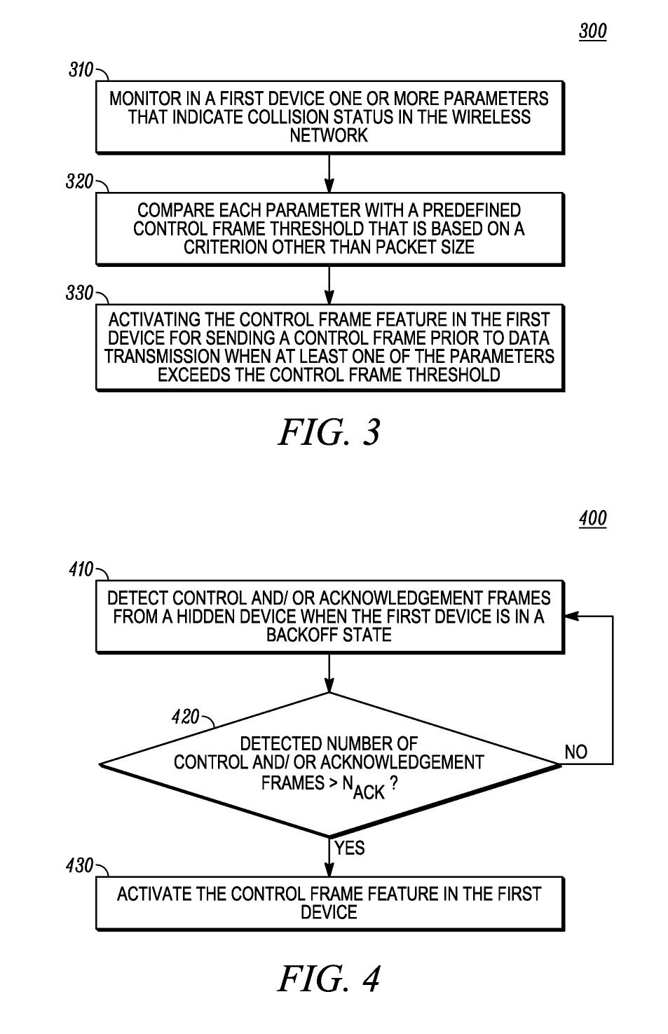

Turning now to FIG. 3, a flow diagram illustrating a method to use a control frame feature dynamically in a wireless communication system is shown. The method 300 in general is used to make an intelligent decision about the usage of a control frame feature to, among other reasons, facilitate reliable data recovery in the wireless communication system 100. At a step 310, a wireless communication device in a wireless system (such as system 100) monitors one or more parameters that indicate collision status in the wireless network. The collision status could be a current collision status, meaning that the parameter gives some indication that packets are currently not being delivered due to collision with transmissions from other devices in the network. Parameters such as a collision rate value and a number of retransmission attempts indicate a current collision status in the network. The collision status could also be an anticipated collision condition in the network as indicated by, for example, a hidden terminal condition or an increase in the number of stations occupying the network. These are exemplary parameters that indicate collision status in the network, but other parameters are contemplated and within the scope of the teachings herein. For example, in some circumstances it may be desirable to activate a control frame feature in a device based on a past history of collisions in the wireless network.

For each such parameter (indicating collision status) that is monitored by the device, the device compares the parameter with a corresponding predefined threshold, at a step 320. Each threshold in this case is based on a criterion other than packet size, which is different from techniques in the prior art. The thresholds instead provide for an objective measure beyond which use of a control frame feature is beneficial due to indicated collision status in the network. If any monitored parameter exceeds its corresponding threshold, the device then activates its control frame feature, at a step 330, so that the device sends a control frame to reserve the channel prior to a data transmission. Once the control frame feature is activated, the device also desirable continues to monitor the parameters in the network that indicate collision status in order to deactivate the control frame feature where the collision status in the network indicates that such as feature is not needed or is not as beneficial.

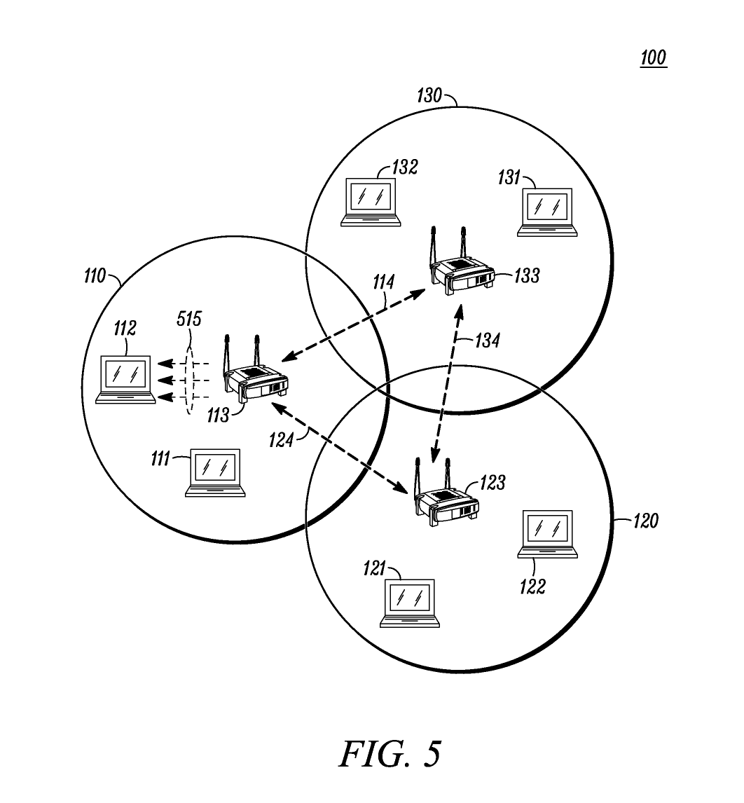

FIG. 4 and FIG. 5 illustrate a first embodiment of the invention, wherein the parameter monitored anticipates a future collision condition in the network based on a hidden terminal condition in the network. A hidden terminal is defined in the context of at least two devices and is also referred to herein as an “unknown” device or a device that is not a neighbor device within the same coverage area. Take the situation of two devices A and B that are in different coverage areas that, therefore, cannot hear each other but that can transmit to and receive from a common device C. In this situation, device A is a “hidden terminal” with respect to device B and vice versa. In the presence of a hidden terminal condition, it may be desirable for a wireless device to activate its control frame feature in order to avoid transmission collision with the hidden terminal.

Turning now to FIG. 4, a flow diagram illustrating a method 400 for using a control frame feature based on a communication device receiving response control frames or acknowledgement (ACK) frames from unknown devices, in accordance with embodiments of the invention is shown. Prior to describing the steps of method 400, it should be noted that in certain systems, such as 802.11 systems, devices within a given coverage area can usually “hear” transmissions (or detect transmissions because they are in reception range) from any other devices with the same coverage area (also called neighbor devices). This makes it easier for a device to avoid collisions with other devices within the same coverage area. However, this is typically not the case for hidden terminal conditions unless a device is somehow made aware of particular a hidden terminal, especially during a time when the device is preparing to send a transmission that may collide with a transmission from the hidden terminal.

To address the above scenario, at a step 410 a communication device monitors frames being transmitted in its coverage area to detect either ACK frames (that a receiving device sends to a transmitting device confirming receipt of a data transmission), response control frames (such as CTS frames sent in response to an initiating control frame such as a RTS frame) or both, which are sent by a device that is not a neighbor device (that is a hidden terminal) to the detecting device. For example, a device 112 comprising system 100 (which is reproduced in FIG. 5) and configured in accordance with embodiments of the invention is monitoring packets and detects several ACKs (and/or CTS) 515 sent by a device 113 to a device 133, which is not a neighbor to device 112, with the ACKs (CTS) being detected optimally while device 112 is in a “backoff” state. Device 112 could recognize device 133 as an unknown device, for example, by detecting an acknowledgement without detecting a preceding data frame or detecting a response control frame (e.g., a CTS frame) without detecting a preceding control frame (e.g., a RTS frame).

Moreover, as stated earlier optimally device 112 detects frames 515 while device 112 in a backoff state. A backoff state is defined herein in general as a period of time during which a device has prepared a transmission but is waiting to send the transmission because it has received an indication that the channel is “busy” (e.g., is being used by another device). The 802.11 standards provide for specific backoff procedures. However, backoff procedures which dictate whether a device is in a backoff state can change depending on the particular protocols implemented in the communication system. In addition, detecting the ACK/CTS frames 515 while device 112 is in a backoff states provides the greatest opportunity for avoiding collision between a data transmission of device 112 intends to send and one from the hidden terminal.

Upon detecting frames 515, device 112 determines how many frames 515 were received while in its backoff state and compares this number of detected ACK/CTS frames to a predetermined threshold, N_{ack}, at a step 420. If the detected number of control and/or acknowledgement frames exceeds N_{ack}, device 112 activates its control frame feature, at a step 430, to send a control frame (e.g., a RTS frame) prior to sending its data transmission. Otherwise device 112 continues detecting control and/or acknowledgement frames in step 410. In one exemplary implementation, N_{ack} is a number of consecutive events of receiving an ACK or CTS frame from an unknown device. The number of consecutive events could be detected over a certain time period. The technique for processing the number of CTS and ACK frames could include, but is not limited to, time average, moving average, etc.

The ACK or CTS frames could furthermore be from the same unknown device or different unknown devices. It should be realized that N_{ack} could be as few as one (1) such event under certain circumstances such as, for instance, where a system capacity is at a certain predefined limit. The use of a control frame feature (e.g., transmission of RTS frames) prior to actual data transmission helps to distribute medium reservation information throughout the medium and hence prevent any possible collision of packets in the medium. Accordingly, method 400 is a proactive method to avoid collision of packets by activating the control frame feature upon detecting a hidden terminal condition that can potentially lead to collision.

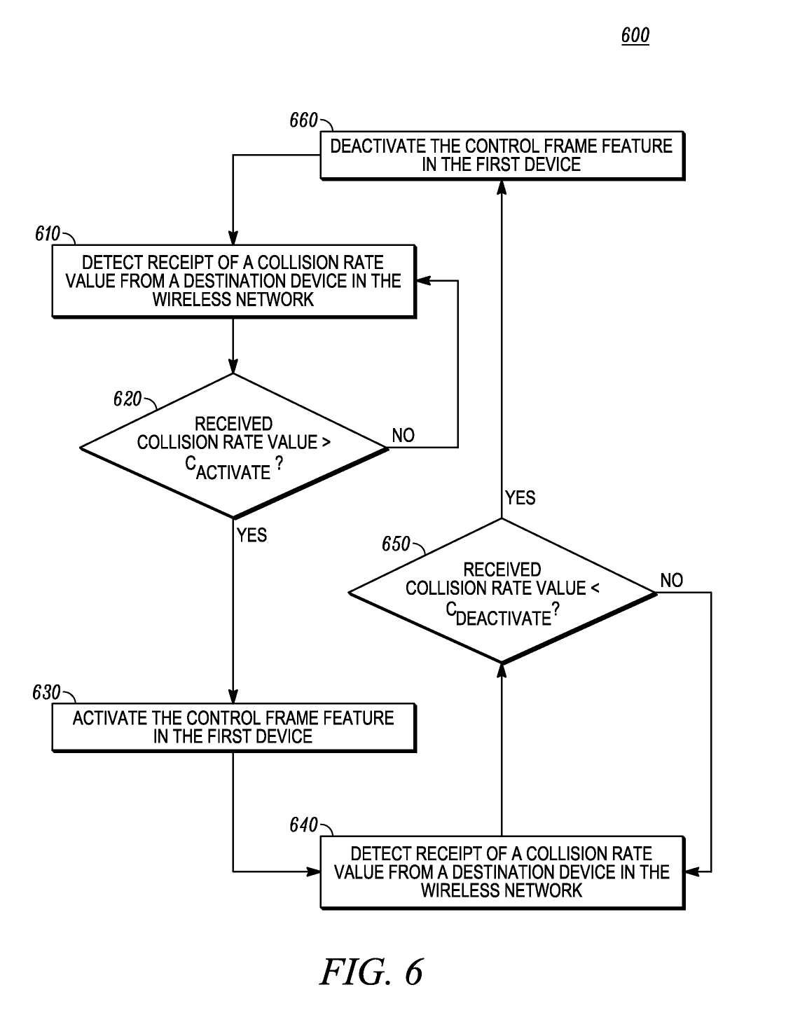

FIG. 6 through FIG. 9 illustrate a second embodiment of the invention, wherein the parameter monitored indicates a current collision condition in the network based on a collision rate value provided by a “destination” device in the network. FIG. 6 illustrates a flow diagram of a method 600 for implementing this second embodiment. At a step 610, a communication device in a wireless network detects receipt of a collision rate value from a destination device. A destination device in this context is a device that is an intended recipient of a transmission from another device in the network. In an infrastructure-based network, the destination device for the stations in a coverage area is the access point since the access point is an intermediary device for transmissions between two or more stations and is thus an intended recipient even if only to forward the data transmission to another terminal. However, in an ad-hoc network, another station is usually the destination device since access points are typically not used in such a network, as the stations themselves perform the routing.

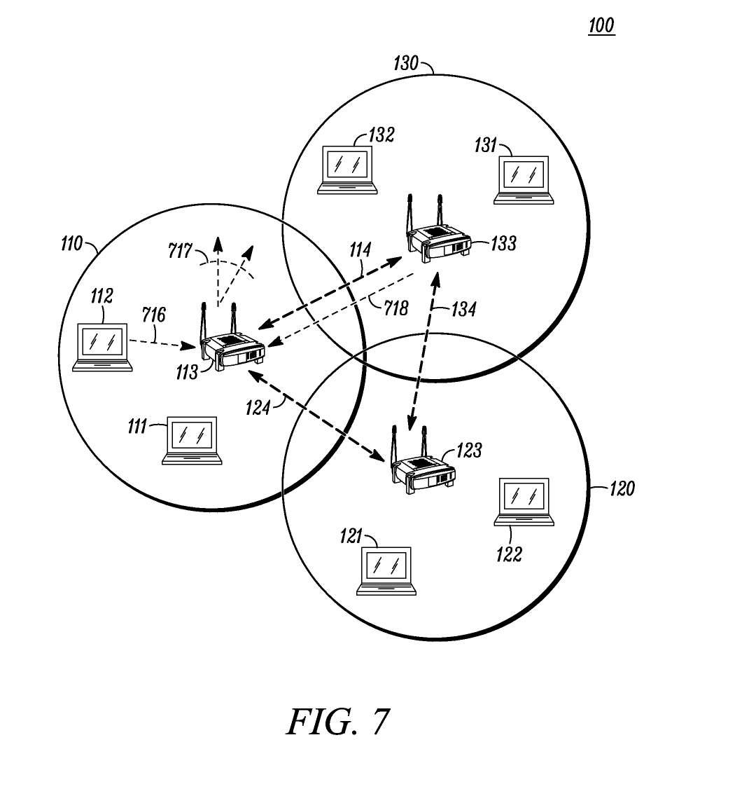

Suppose, for example, that device 112 comprising system 100 (which is reproduced in FIG. 7) and configured in accordance with embodiments of the invention intends to send a data transmission to access point 113. Prior to sending the data transmission, it detects receipt of a collision rate value transmitted 717 by access point 113 in coverage area 110. The collision rate value can be transmitted by the access point 113 and received by the station 112 using any suitable means. For example, a simple control or management frame including the collision rate value can be sent periodically in a broadcast message to neighboring stations (and access points if desired). However, it should be readily realized by those of ordinary skill in the art that the collision rate information could in other implementations be sent using a multicast message or unicast messages. For instance, in one exemplary implementation a station first entering the coverage area of access point 113 and having an intended transmission may (upon successful handoff) request collision rate information from the access point, which may be transmitted in a unicast message. Furthermore, detecting receipt of a collision rate value encompasses a device detecting that it has received a message from the destination device that includes the collision rate value and reading that value from the message. Detecting receipt of the collision rate value likewise encompasses a device determining that it has stored a collision rate value that was earlier received from the destination device and reading the value from memory (e.g., from memory 226 shown in FIG. 2).

Upon detecting the collision status value, at step 620, device 112 compares the received collision rate value to a predefined collision rate threshold C_{activate}, to determine whether to activate its control frame feature to send a control frame (e.g., a RTS frame) prior to sending its data transmission. A suitable C_{activate} can be determined based on factors including, but not limited to type of traffic to be transmitted (e.g. voice might have a different threshold compared to data traffic because in general voice traffic is more sensitive to the collision due to its delay sensitive nature), system loading, local congestion level, the channel quality indicated by Received Signal Strength (RSS), allowable link rate, etc, and device 112 could be preconfigured with the threshold value or receive the threshold value through one or more transmissions, e.g., from access point 113. If the received collision rate value exceeds C_{activate}, device 112 activates (at a step 630) the control frame feature. Otherwise device 112 continues detecting receipt of the collision rate value at step 610.

After activating its control frame feature, device 112 continues monitoring the collision rate value from access point 113 (at a step 640) and compares the collision rate value to a second predefined threshold, C_{deactivate}, at a step 650. Threshold C_{deactivate} provides an objective measure below which it would be beneficial to deactivate the control frame feature or below which such a feature is not needed because of the current collision status condition in the wireless network as determined by access point 113. Similar to C_{activate}, a suitable C_{deactivate} can be determined based on factors including, but not limited to type of traffic to be transmitted, system loading, local congestion level, the channel quality indicated by Received Signal Strength (RSS), allowable link rate, etc., and device 112 could be preconfigured with the deactivation threshold value or receive the deactivation threshold value through one or more transmissions, e.g., from access point 113. Moreover, C_{activate} and C_{deactivate} can be the same or different values. In one implementation, C_{deactivate} is a smaller value (e.g., 50%) than C_{activate} (e.g., 57%). To set C_{deactivate} different from (e.g. smaller than) C_{activate} is to avoid ping-pong effect (STA keeps shifting between activating and deactivating using control frame).

Accordingly, where the received collision rate value is less than the C_{deactivate} for a predefined interval, device 112 deactivates its control frame feature, at a step 660, and sends its transmissions without a preceding control frame. The predefined interval can be, for instance, a predefined time interval over which the received collision rate value falls below C_{deactivate}, or a predefined number of consecutive retransmission attempts of a data packet from device 112 to access point 113, during which time the received collision rate value is below C_{deactivate}. In any event, whether device 112 decides at step 650 to deactivate its control frame or not, device 112 continues to monitor the collision rate value (either at step 640 or at step 610) received from access point 113 to continue to facilitate the dynamic use of its control frame feature, in accordance with this embodiment, based on network conditions that indicate a current collision status in the wireless network 100.

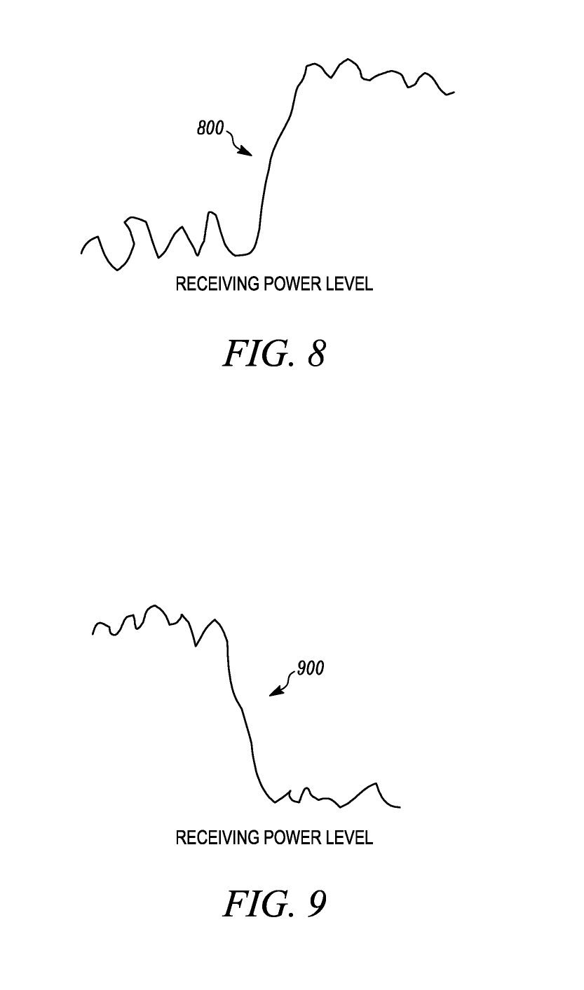

FIG. 8 and FIG. 9 illustrate waveforms considered by a device (e.g., access point 113) in determining the collision rate value that it transmits to one or more devices (e.g., device 112) to use in implementing method 600 of FIG. 6. As mentioned above, the collision rate value can be determined using the collision status measurement unit 227 (illustrated in FIG. 2), which is also referred to herein as a “collision detector”. In general, computation of the collision rate value requires a communication device to be able to distinguish between the scenario of loss of packets due to channel error and loss of packets due to collisions. This can be done, in one implementation, using the simple collision detector described as follows.

A device in network 100 (e.g., access point 113) can be configured using known technologies to detect power level of a signal (comprising packets) received at the device, which is hereinafter referred to as a “receiving power level” of the detected signal. This receiving power level can be used by access point 113 to determine the collision rate value. For example, where a first communication device (e.g., station 112) is transmitting (716) a packet to access point 113 and a second communication device (e.g., AP 133) starts transmitting (718) another packet before station 112 is finished with its transmission (note that AP 133 is hidden from STA 112), access point 113 usually detects a sudden jump in the receiving power level as illustrated by waveform 800 in FIG. 8. Moreover, where stations 112 and AP 133 start transmitting packets to access point 113 at the same time, if one station concludes its transmission while the other continues to transmit, access point 113 usually detects a sudden drop in the receiving power level as illustrated by waveform 900 in FIG. 9.

In both of the above cases, the change in receiving power level is due to packet loss because of collisions, and access point 113 could count each such event to determine the collision rate value. For example, in one simple implementation access point 113 could count the total number (T) of transmissions received over a given time interval and the total number (P) of events of a sudden drop or a sudden increase in receiving power level over the same time interval. The collision rate value for that time interval would then be (P/T). Conversely, access point 113 could detect packet loss due to channel error by detecting that the receiving power level has remained below a certain threshold over a certain time interval, in order to distinguish packet loss due to collisions from packet loss due to channel errors. In this manner, a device receiving the collision rate value activates its control frame feature (or deactivates it) based only on packet loss that is due to collisions. As explained above, this conserves valuable bandwidth during conditions of packet loss due to channel error.

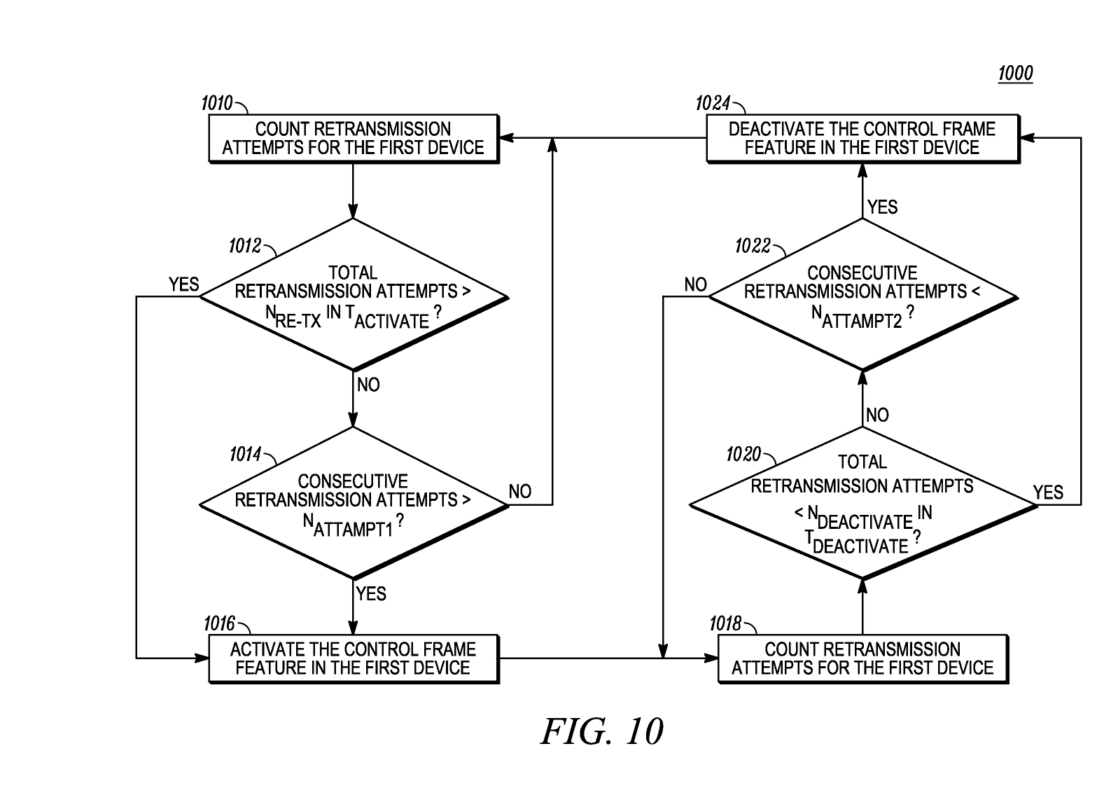

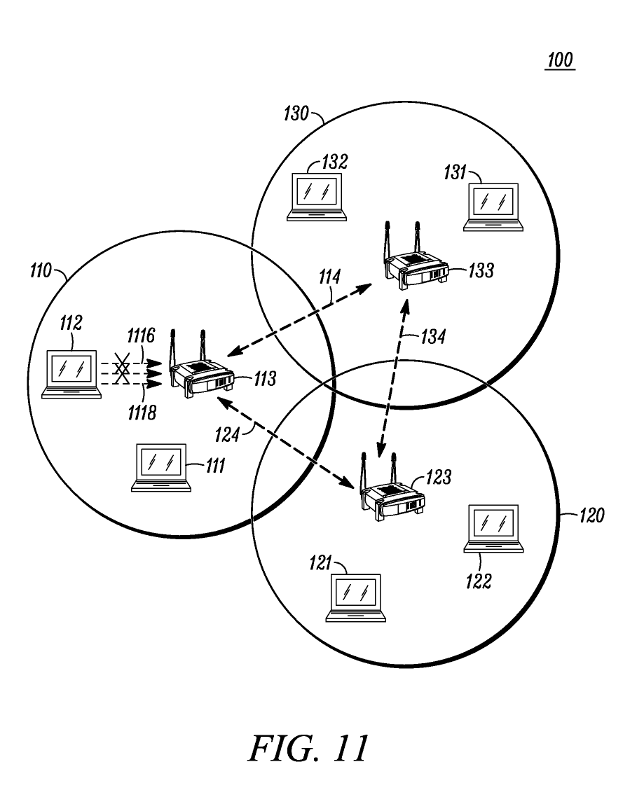

FIG. 10 and FIG. 11 illustrate a third embodiment of the invention, wherein the parameter monitored indicates a current collision condition in the network based on retransmission attempts by a device in the network. As stated above, 801.11 systems (as an example) require receipt of an ACK by a transmitting device after every data transmission. However, the transmitting device may not receive the ACK because either the transmitted packet or its ACK was lost due to channel error or due to collision with another packet in the medium. If the transmitting device does not receive the ACK within a defined period of time, it usually retransmits the packet. This process of retransmission (also referred to herein as “retransmission attempts”) is repeated by the transmitting device until it receives an ACK (or perhaps for a predefined limited number of retransmission attempts). A substantial number of repeated transmission attempts, however, is undesirable because they can consume a large portion of system resources. Accordingly, the third embodiment of the invention uses the parameter of retransmission attempts to control the activation (and deactivation) of a device's control frame feature to prevent collision of packets in a wireless system to, thereby, reduce the number of retransmissions.

FIG. 10 illustrates a flow diagram of a method 1000 for implementing this third embodiment. At a step 1010, a device (e.g., station 112) in system 100 (reproduced in FIG. 11) counts retransmission attempts (e.g., 1116 and 1118) for one or more packets to a destination device (e.g., access point 113) in the wireless communication system. In this manner, a total number of retransmission attempts is generated as corresponds to, for instance, a certain time frame, a particular packet being transmitted, etc., depending on a given implementation. At a step 1012, the total number of transmission attempts is compared with a predetermined threshold, N_{RE-TX}. If the total number of retransmission attempts exceeds the predetermined threshold N_{RE-TX} within a predetermined time interval of T_{ACTIVATE}, station 112 activates (at a step 1016) its control frame feature. Otherwise station 112 compares (at a step 1014) consecutive retransmission attempts (for a packet) with another predetermined threshold N_{ATTEMPT1}. If the consecutive number of retransmission attempts exceeds the second predetermined threshold N_{ATTEMPT1}, station 112 activates (at step 1016) its control frame feature. Otherwise station 112 continues the counting of retransmission attempts (at step 1010). It should be noted that although this implementation includes comparing a number of retransmission attempts to two different thresholds, either one of these thresholds or a different suitable threshold can be used without departing from the scope of the teachings herein. Moreover, the technique for processing the number of retransmission attempts could include, but is not limited to, time average, moving average, etc.

Once the control frame feature is activated in station 112 it again starts counting the retransmission attempts for one or more packets to access point 113, at a step 1018. At a step 1020, the total number of transmission attempts is compared with a third predetermined threshold N_{DEACTIVATE}. If the total number of retransmission attempts is less than the predetermined threshold N_{DEATIVATE} within a time interval of T_{DEACTIVATE}, station 112 deactivates (at a step 1024) the control frame feature otherwise station 112 compares (at a step 1022) consecutive retransmission attempts (for a packet) with a fourth predetermined threshold N_{ATTEMPT1}. If the consecutive number of retransmission attempts is less than the predetermined threshold N_{ATTEMPT2}, station 112 deactivates (at step 1024) the control frame feature. Otherwise station 112 continues the counting of retransmission attempts (at step 1018). It should be noted that value for the thresholds N_{RE-TX}, N_{ATTEMPT1}, T_{ACTIVATE}, N_{DEACTIVATE}, T_{DEACTIVATE}, N_{ATTEMPT1} can be set based on a number of factors including, but not limited to, type of traffic to be transmitted, system loading, local congestion level, the channel quality indicated by Received Signal Strength (RSS), allowable link rate, etc.

In the foregoing specification, specific embodiments of the present invention have been described. However, one of ordinary skill in the art appreciates that various modifications and changes can be made without departing from the scope of the present invention as set forth in the claims below. For example, three separate process embodiments are illustrated herein, and a single device could be configured to implement one, all or any combination of these embodiment. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

What is claimed is:

1. A method for use of a control frame feature in a wireless network, the method comprising the steps of:
monitoring at a first device in the wireless network at least one parameter that indicates collision status in the network;
comparing the at least one parameter to a predefined control frame threshold that is based on a criterion other than packet-size; and
activating a control frame feature in the first device for sending a control frame prior to data transmission, when the at least one parameter exceeds the control frame threshold.

2. The method of claim 1, wherein the step of monitoring the at least one parameter comprises detecting at least one of a response control frame and an acknowledgement (ACK) message from at least a second device in the network that is transmitted to a third device, which is unknown to the first device, when the first device is in a backoff state.

3. The method of claim 2, wherein:
the control frame threshold comprises a predefined first number of consecutive times that the first device detects a response control frame or an ACK message from a second device to an unknown third device; and
the first device activates the control frame feature after detecting a response control frame or an ACK message a second number of consecutive times that exceeds the predefined first number of consecutive times.

4. The method of claim 2, wherein the response control frame is a Clear-to-Send (CTS) message.

5. The method of claim 1, wherein the control frame is a Request-to-Send (RTS) message.

6. The method of claim 1, wherein the step of monitoring the at least one parameter comprises detecting receipt of a collision rate value from a second destination device in the wireless network.

7. The method of claim 6, wherein:
the control frame threshold comprises a first predefined collision rate threshold; and
the first device activates the control frame feature after detecting that the received collision rate value exceeds the predefined collision rate threshold.

8. The method of claim 7 further comprising the step of deactivating the control frame feature after detecting that the received collision rate value has fallen below a second predefined collision rate threshold for a predefined interval.

9. The method of claim 8, wherein the predefined interval comprises at least one of:
a predefined time interval; and
a predefined number of consecutive attempts to send a message to the second device.

10. The method of claim 6, wherein the collision rate value is received in one of a unicast message, a broadcast message and a multicast message from the second device.

11. The method of claim 6, wherein the collision rate value is determined by detecting a receiving power level and detecting an increase or decrease in the receiving power level.

12. The method of claim 1, wherein the step of monitoring the at least one parameter comprises counting retransmission attempts by the first device for a message destined to a second device in the wireless network to generate counted retransmission attempts.

13. The method of claim 12, wherein:
the control frame threshold comprises one of a first predefined number of consecutive retransmission attempts and a second predefined number of retransmission attempts during a predefined time interval; and
the first device activates the control frame feature after detecting that the counted retransmission attempts exceeds the first predefined number of consecutive retransmission attempts or that the counted retransmission attempts exceeds the second predefined number of retransmission attempts during the predefined time interval.

14. The method of claim 13 further comprising the step of deactivating the control frame feature after detecting that the counted retransmission attempts has fallen below a third predefined number of consecutive retransmission attempts or that the counted retransmission attempts has fallen below a fourth predefined number of retransmission attempts during a second time interval.

15. A device for wireless communication in a wireless network comprising:
receiver apparatus for receiving a first radio frequency signal comprising received messages;
a processing device coupled to the receiver apparatus for,
monitoring at a first device in the wireless network at least one parameter that indicates collision status in the network;
comparing the at least one parameter to a predefined control frame threshold that is based on a criterion other than packet-size; and
activating a control frame feature in the first device for sending a control frame prior to data transmission, when the at least one parameter exceeds the control frame threshold; and
transmitter apparatus coupled to the processing device for transmitting a radio frequency signal comprising the control frame.

16. The device of claim 15, wherein:
the device is operable in accordance with Institute of Electrical and Electronics Engineers 802.11 standards; and
the transmitted control frame comprises a Request-to-Send (RTS) message.

17. A computer-readable storage element having computer readable code stored thereon for programming a computer to perform a method for use of a control frame feature in a wireless network, the method comprising the steps of:
monitoring at a first device in the wireless network at least one parameter that indicates collision status in the network;
comparing the at least one parameter to a predefined control frame threshold that is based on a criterion other than packet-size; and
activating a control frame feature in the first device for sending a control frame prior to data transmission, when the at least one parameter exceeds the control frame threshold.

18. The computer-readable storage element of claim 17, wherein:
the step of monitoring the at least one parameter comprises detecting at least one of a response control frame message and an acknowledgement (ACK) message from a second device to a third device in the network that is unknown to the first device, when the first device is in a backoff state;
the control frame threshold comprises a predefined first number of consecutive times that the first device detects a response control frame or an ACK message from a second device to a third unknown device; and
the first device activates the control frame feature after detecting a response control frame or an ACK message a second number of consecutive times that exceeds the predefined first number of consecutive times.

19. The computer-readable storage element of claim 17, wherein:
the step of monitoring the at least one parameter comprises detecting receipt of a collision rate value from a second destination device in the wireless network;
the control frame threshold comprises a first predefined collision rate threshold; and
the first device activates the control frame feature after detecting that the received collision rate value exceeds the predefined collision rate threshold.

20. The computer-readable storage element of claim 17, wherein:
the step of monitoring the at least one parameter comprises counting retransmission attempts by the first device for a message destined to a second device in the wireless network to generate counted retransmission attempts;
the control frame threshold comprises one of a first predefined number of consecutive retransmission attempts and a second predefined number of retransmission attempts during a predefined time interval; and
the first device activates the control frame feature after detecting that the counted retransmission attempts exceeds the first predefined number of consecutive retransmission attempts or that the counted retransmission attempts exceeds the second predefined number of retransmission attempts during the predefined time interval.
